(19) United States
(12) Patent Application Publication
(10) Pub. No.: US 2002/0194094 A1
(43) Pub. Date: Dec. 19, 2002

(54) System and method for providing financial products

(75) Inventors: Eric Scott Lancaster, Arlington, VA (US); Robert W. Stradtman, Arlington, VA (US)

Correspondence Address: FINNEGAN, HENDERSON, FARABOW, GARRETT &, DUNNER LLP, 1300 I STREET, NW, WASHINGTON, DC, 20006, US

(73) Assignee: CAPITAL ONE FINANCIAL CORPORATION

(21) Appl. No.: 09/881,743

(22) Filed: Jun. 18, 2001

(51) Int. Cl. G06F 17/60

(52) U.S. Cl. 705/35

(57) ABSTRACT

Systems and methods are disclosed for providing financials products to customers. Preferably, a financial product is provided to a customer in association with one or more other financial products. The financial products may correspond to different product categories and may be particularly adapted or suited according to a customer's financial needs. In addition, different product combinations may be offered to customers. For example, a financial product for investing or generating income (such as a savings account, a money market account or a CD account) may be provided in association with a financial product for conducting financial transactions (such as a loan, a mortgage or a credit card account). Additionally, one financial product may be used as security for another financial product of the customer. The financial products may also be structured to maximize the total return and/or utility received by the customer.

### BACKGROUND OF THE INVENTION

I. Field of the Invention

The present invention relates to systems and methods for offering and providing financial products. More particularly, the invention relates to systems and methods for offering and providing a financial product that is associated with at least one other financial product.

II. Background and Material Information

In today's marketplace, a wide range of financial products are available to the public. For example, financial products such as loans, checking accounts, credit cards and debit cards are used by customers for purchasing goods and services. These types of products can also be used for conducting other types of financial transactions, such as refinancing and debt consolidation or repayment. While extremely useful, these types of products often impose an obligation-to-pay on the customer and typically charge fees and/or interest based on the funds used or credit extended to the customer.

Other types of financial products are also available to customers for the purposes of generating income or investing. Financial products, such as savings accounts, money market accounts, bonds and certificates of deposits (CDs), offer interest or income to customers in exchange for the deposit and/or use of their funds. The income may be fixed or variable depending on the type of financial account opened by the customer. Some of these products include check drafting or cash withdrawal capabilities. However, in most cases, such features are limited in scope or trigger certain penalties or fees imposed on a customer.

Until recently, the financial industry has been a highly segmented market. In the past, customers were required to contact several different financial entities to open accounts based on their financial needs. For example, a customer would need to contact a local bank to open a savings account and also be required to contact a credit card issuer to open a credit card account. The same customer may also have one or more loans with a major lending institution and/or obtain bonds through a brokerage house. This arrangement has many drawbacks, including increased difficulties in account management and the offering of financial accounts that are not particularly suited for the individual customer. Conventional arrangements also fail to maximize the benefit and utility of accounts for customers.

In view of such drawbacks, there has been attempts by financial institutions to offer a wider array of financial products to customers. For instance, some financial institutions offer not only accounts for conducting transactions (such as loans or credit cards), but also offer accounts for investing or generating income (such as bonds or certificates of deposit). While such advancements have been made, most financial institutions do not consider the individual needs of the customer or effectively offer one financial product in association with one or more other financial products. In addition, past attempts fail to maximize the total return and utility received on related financial products.

### SUMMARY OF THE INVENTION

In accordance with the present invention, systems and method are provided for offering and providing financial accounts to customers. The financial products may include a base product (such as a savings account, a money market account, or a CD account) and at least one associated product (such as a loan, a mortgage, or a credit card account). Generally, such systems and methods receive a request from a customer concerning the base product; gather customer information in response to the request from the customer; determine, based on the customer information, whether predetermined solicitation criteria is satisfied for offering at least one associated product; and present, if the predetermined solicitation criteria is satisfied, an offer to the customer concerning the associated product. If the offer is accepted by the customer, then an application for the base product and the associated product is processed for the customer.

Systems and methods consistent with the principles of the invention provide a financial product to a customer that is associated with at least one other financial product offered by a financial institution. The terms (i.e., market interest rate, fees, etc.) of each financial product are set to provide maximum utility and benefit to the customer, while also providing acceptable rates of return and/or benefit to the financial institution. In addition, the terms that are offered to the customer may be set more competitive than current market terms due to the manner in which the financial products are associated with one another. For example, one of the financial products may act as a security for the other financial product. By providing this security aspect, the risk premium related to the secured financial product is lowered and, therefore, more competitive terms can be offered to the customer.

Methods consistent with the principles of the invention provide financial accounts, wherein the financial products include, for example, a first financial account for investing and a second financial account for conducting transactions. Such methods perform one or more of the following steps: gathering information related to a customer, the customer information including credit information for a customer and a customer's preferences concerning the first financial account; generating at least one offer for the first financial account combined with the second financial account, each offer including terms for the first financial account and the second financial account that are determined based on the gathered customer information; presenting each offer to the customer for selection; and processing, if the offer is selected by the customer, an application for the first financial account and the second financial account corresponding to the selected offer.

In such methods, the first financial account may comprise a savings account, a money market account, a CD account, or a bond. Additionally, the second financial account may comprise a checking account, a debit card account, a credit card account, a mortgage or a loan. Each offer presented to a customer for the first financial account and the second financial account may include different sets of terms for the accounts. Such terms may include applicable interest rates for each financial account, wherein the rates are set at prevailing market rates or at a rate that is higher or lower from the corresponding market rate.

Systems consistent with the principles of the invention further include: means for receiving a request from a customer concerning a financial account (such as a CD account); means for gathering customer information; means for generating, in response to the request from the customer, at least one offer for the CD account and an associated financial product (such as a credit card account), the offer including interest rates for the CD account and the credit card account that are adjusted based on the customer information; means for presenting, to the customer, the offer for the CD account and the credit card account; and means for processing an application for the CD account and the credit card account if the offer is accepted by the customer.

Optionally, the presenting means includes means for presenting a set of offers for the CD account and the credit card account to the customer, wherein each offer includes a unique combination of rates for the CD account and the credit card account. Such systems may also include means for processing an application for the CD account if the customer rejects the offers for the CD account and the credit card account. Additionally, the system may include means for processing, if one of the offers is selected by the customer, an application for the CD account and the credit card account in accordance with the offer selected by the customer.

Systems and methods consistent with the principles of the invention also receive a request from a customer concerning a financial account for investing (such as a CD account); determine in response to the request from the customer, a customer's preferences regarding the CD account; generate, based on the customer's preferences regarding the CD account, a set of offers for the CD account and a financial account for conducting transactions (such as a credit card account); present the set of offers to the customer; and process an application for the CD account and the credit card account in accordance with the offer selected by the customer.

Systems and methods are also disclosed that gather information related to a customer; generate, using an offer determination module, at least one offer for a CD account and a credit card account; present each offer to the customer; and process an application for the CD account and the credit card account in accordance with the offer selected by the customer. In such systems and methods, each offer may include terms for the CD account and the credit card account that are determined based on the customer information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate the features and aspects of the invention and together with the description, serve to explain the principles of the invention.

In the drawings:

FIG. 1 is a diagram of an exemplary system environment, consistent with the principles of the present invention;

FIG. 2 is an exemplary flowchart of a method for providing financial accounts, consistent with the principles of the invention;

FIGS. 3A and 3B are exemplary flowcharts of additional methods for providing financial products, consistent with the principles of the invention;

FIGS. 4A and 4B are exemplary flowcharts of yet other methods for providing financial products, consistent with the principles of the invention;

FIG. 5 illustrates an exemplary offer determination module, consistent with the principles of the invention; and

FIGS. 6A and 6B illustrate exemplary source tables for determining the rates or terms of financial products offered to customers.

### DETAILED DESCRIPTION

Systems and methods consistent with the principles of the present invention provide financial products to customers. Such systems and methods provide a financial product to a customer in association with one or more other financial products. The financial products may correspond to different product categories and may be particularly adapted or suited according to a customer's financial needs. Optionally, a financial product for investing or generating income may be provided in association with a financial product for conducting financial transactions. Additionally, one financial product may be used as security for another financial product of the customer. The financial products may also be structured to maximize the total return and/or utility received by the customer. For example, the financial products may be offered with competitive terms due to the relation or association of the products.

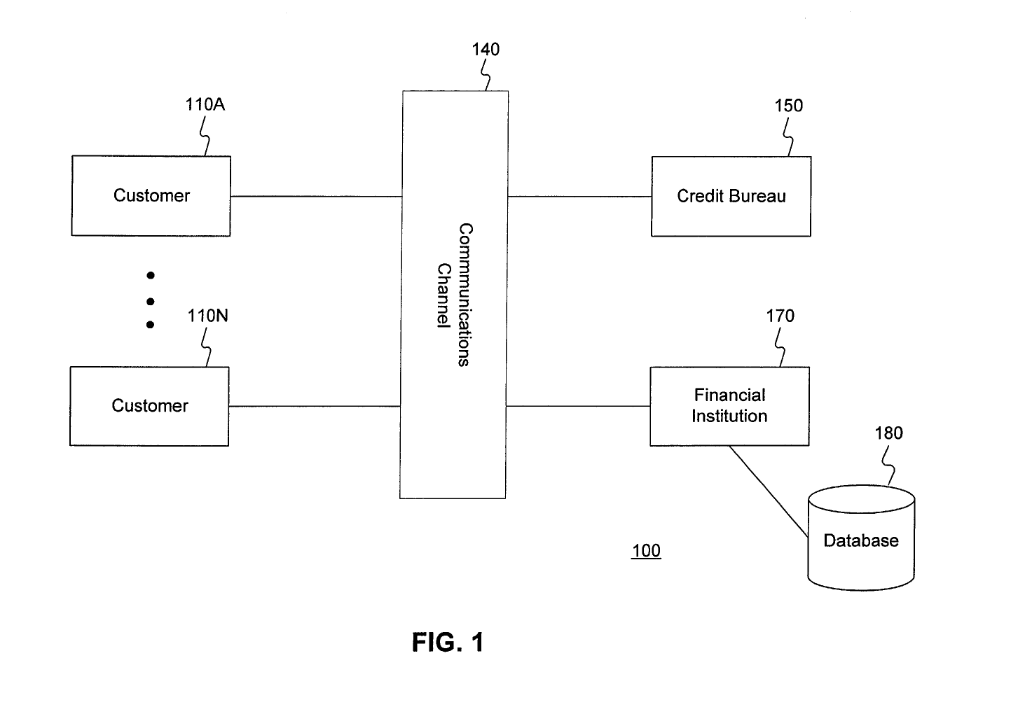

FIG. 1 illustrates an exemplary system environment 100, consistent with the principles of the invention. System environment 100 includes a number of customers 110A-110N who communicate with a financial institution 170 through a communication channel 140. Financial institution 170 may offer a number of financial products to customers 110A-110N. Such financial products may include savings accounts, money market accounts, CD accounts, bonds, debit accounts, credit card accounts, loans and/or other types of financial products. Each financial product or account may be activated and maintained for customers using a database 180. Financial and credit information from a credit bureau 150 and other sources may also be used by financial institution 170 for analyzing and providing financial accounts to customers.

Although FIG. 1 illustrates one financial institution 170 and communication channel 140, a number of financial institutions and communication channels may be provided. Further, it will be appreciated that although FIG. 1 illustrates one database 180 and credit bureau 150, a number of credit bureaus and databases may be provided.

Consistent with the principles of the invention, communication channel 140 may comprise any combination of technology or components for providing electronic or physical communication. For electronic or on-line communication, communication channel 140 may comprise wired or wireless technologies and/or public communication networks, such as the Internet or a public switched telephone network (PSTN). For physical or in-person communication, communication channel 140 may comprise store locations or kiosks, as well as mailing and advertisement campaign systems for communicating with customers.

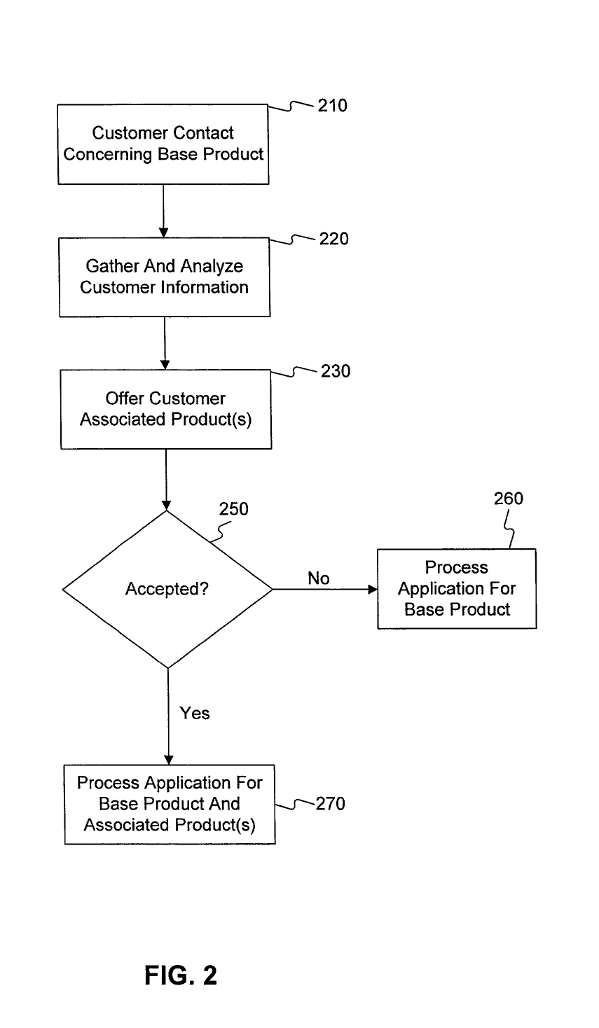

To facilitate communication through channel 140, each customer 110A-110N may include a personal computer, workstation, laptop, personal digital assistant (PDA), wireless phone, mobile phone, standard telephone or other device capable of communication. Such devices may include a modem, transmitter, receiver or transceiver for establishing communication with financial institution 170 over channel 140. For email or Internet based applications, each customer 110A-110N may also include an email application and/or browser software to permit the transmission of email and/or the browsing and viewing of Web pages. Financial institution 170 may also include similar devices or software for communicating with each customer, as well as credit bureau 150. In addition, financial institution 170 may include a call center for handling calls from customers and/or a Web server for hosting a Web site on the Internet and providing content and interactive Web pages to customers. Financial institution 170 may also include one or more software-based applications or modules for communicating with customers and providing the features illustrated in FIGS. 2-6.

FIG. 2 is an exemplary flowchart of a method for providing financial products, consistent with the principles of the present invention. As illustrated in FIG. 2, a customer contacts a financial institution concerning a financial product (step 210). In accordance with the exemplary system environment of FIG. 1, this step can be performed by any one of customers 110A-110N communicating with financial institution 170 through communication channel 140. The contact by the customer may be related to a specific financial product (e.g., a “base product”) offered by the financial institution. Information concerning financial accounts offered by the financial institution can be provided to customers by various communication methods, such as on-line advertisements, offers provided by electronic mail, and advertisements or solicitations sent by standard mail. In addition, such communication may be achieved through various communication channels, such as communication channel 140 of FIG. 1.

After the contact or request is made by the customer, the financial institution gathers and analyzes customer information (step 220). Customer information may include credit history information obtained from one or more sources, such as credit bureau 150. Customer information may also include financial information (e.g., salary, outstanding debt, financial assets, etc.) and demographic information (e.g., age, marital status, address, etc.). Such customer information may be gathered from public records or sources. Alternatively, or in addition to using public sources, customer information may be gathered from a questionnaire or application completed by the customer prior to or after the contact is made (i.e., before or after step 210 in FIG. 2). The questionnaire or application may be completed by the customer electronically (e.g., on-line or using email) or in-person (e.g., orally or through handwritten communication). Additionally, the customer information may include a customer's preference(s) regarding the terms or features of the base product.

The gathered customer information is then analyzed by the financial institution (step 220). The financial institution may analyze the customer information to determine the financial status or needs of the customer. For example, the customer information may be analyzed to determine the financial status of the customer and identify another financial account or product (e.g., an “associated product”) that can be offered to the customer. Optionally, the base product and associated product may be linked or associated in accordance with the financial needs of the customer.

The customer may then be offered one or more associated products based on the analysis of the gathered customer information (step 230). In the exemplary environment of FIG. 1, this step may be performed by an offer from financial institution 170 that is communicated electronically, verbally or by written communication to the customer using communication channel 140. After the offer is presented to the customer, it is determined if the associated product is accepted by the customer (step 250). If the customer declines or rejects the offer for the associated product, the process continues as normal with the customer's request or application for the base product being processed by the financial institution (step 260). If, however, the customer accepts the offer, then the financial institution processes an application for both the base product and the associated product (step 270). In this case, if the customer satisfies all of the requirements for the financial products, accounts may be opened for the customer using, for example, database 180 in the system environment of FIG. 1.

Consistent with the principles of the invention, the terms of the financial accounts or products that are offered by the financial institution may be varied according to the financial status or needs of the customer. In addition, the financial accounts or products may be associated or related so as to provide maximum benefit and utility to the individual customer. For example, assume that there are two customers, customer A and customer B. Customer A has a good credit rating and normally carries little or no balance on her credit card. Further, assume that customer A also has a few thousand dollars to invest. In contrast, assume that customer B has some debt and historically carries a high balance on his credit card. Also, assume that customer B has little or no money in savings and would like to start saving for the future. As a result, customers A and B have different financial needs and, thus, require different solutions.

For purposes of illustration, assume that the base product corresponds to a credit card account and the associated product corresponds to a savings account or Certificate of Deposit (CD). Consistent with the principles of the invention, the yields and interest rates of these products are varied to meet the financial needs and preferences of customers A and B. For example, according to the invention, customer A could be offered a higher yield CD account with a credit card account having an average or higher annualized interest rate. In contrast, customer B could be offered a CD account with a lower yield in combination with a credit card account that has a lower annualized interest rate. If necessary, the CD account could also be used as a security for the credit card account.

Systems and methods consistent with the principles of the invention may analyze one or more factors to determine the best combination of financial products to offer a customer. In addition, the terms or features of the products may be varied based on the financial needs or preferences of each customer. For purposes of illustration, assume once again that the base product relates to a credit card account and the associated product corresponds to a CD account. In such a case, the interest rate and yield for such products could be varied, based on a number of factors, to determine an optimum combination of products to offer to the customer. These factors could include, for example, one or more of the following: the credit history of the customer (e.g., number of open credit accounts, debt-to-income ratio, earning capacity, length of employment, etc.); the annualized interest rate for credit card account(s) offered to similar customers; the deposit balance for the CD account; the time to maturity for the CD account; and, the interest rate or yield offered for similar CD accounts.

Consistent with the principles of the invention, the offer that is presented to the customer (step 230 in FIG. 2) may be for a unique combination of financial products including the base product and one or more associated products. The terms and features of these products may be set by the financial institution and presented as a single offer to the customer. Alternatively, the customer may be presented with a number of offers, where each offer relates to a unique combination of financial products with specific interest rates, yields, fees, etc. Additionally, preferred rates and/or the waiver of fees or conditions may be provided when specific financial accounts are opened in combination with other financial accounts. In this manner, the customer is able to select a combination of financial products that best fits their financial needs or preferences.

In the above-described examples, reference is made to a base product and an associated product. It will be appreciated, however, that the invention is not limited by such terminology. For example, the principles of the invention can be implemented by combining a financial product with other types of financial products (such as a “cross-sell product”, an “up-sell product” or a “down-sell product”). In addition, the principles of the invention can be practiced by offering any financial product in combination with one or more other financial products. For example, a credit card account can be offered in combination with a savings account and a checking account. Alternatively, a CD account can be provided to a customer in combination with an installment loan and a credit card account.

Further, consistent with the principles of the invention, the financial products may be associated with one another to permit more competitive terms to be offered to a customer. For example, assume one of the financial products (such as a savings account or CD account) acts as a security for the other financial product (such as a loan or a secured credit card). By providing this security aspect, the risk premium related to the secured financial product is lowered and, therefore, the financial institution can offer competitive terms to the customer. More competitive terms (such as interest rates or dividends) can also be offered when a customer increases his/her total deposits with the financial institution by opening a number of associated financial products that have deposit requirements (such as savings accounts, money market accounts, CD accounts, etc.).

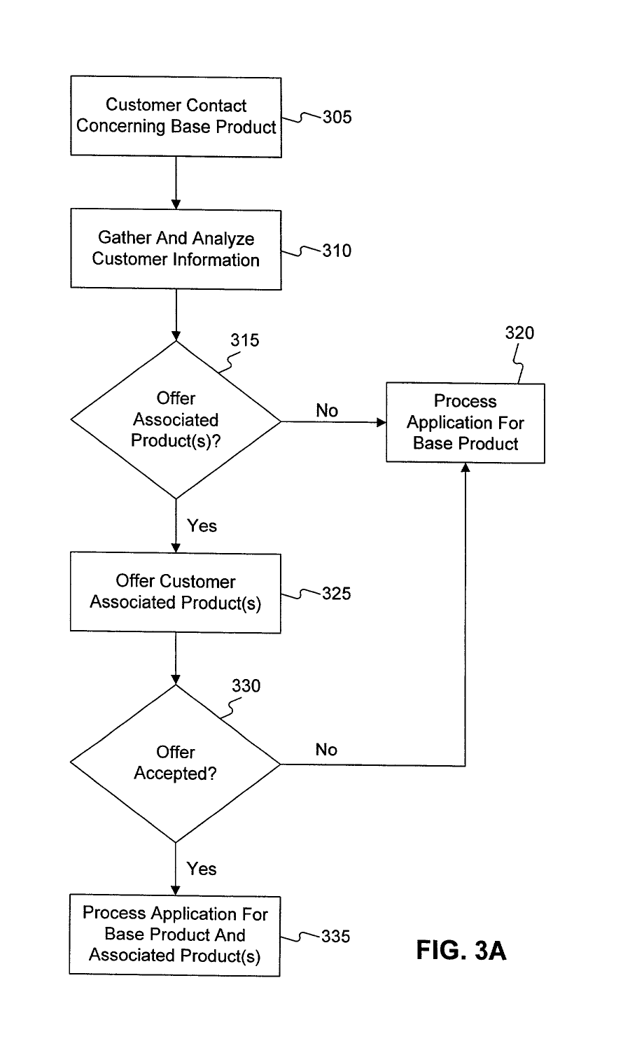

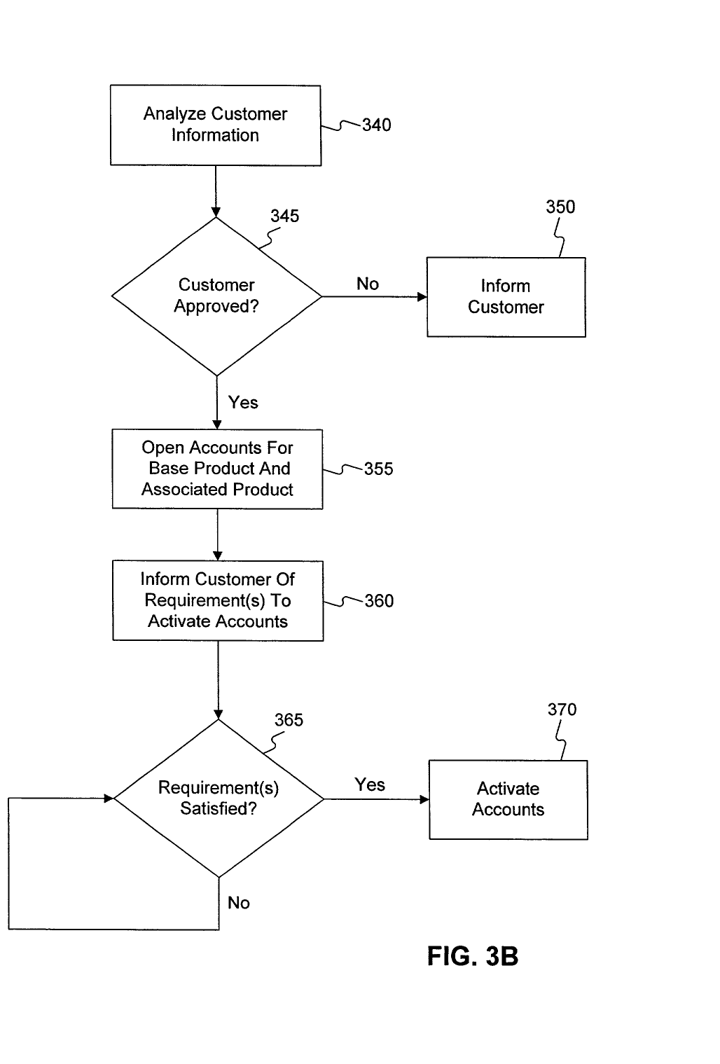

FIGS. 3A and 3B illustrate exemplary embodiments for offering financial accounts, consistent with the principles of the invention. In the exemplary embodiments of FIGS. 3A and 3B, the financial products are referred to as a base product and an associated product. As disclosed herein, such products may be offered to customers based on their financial needs or preferences. In addition, the base product and associated product may be linked or related with one another to provide additional benefits or advantages to the customer. For example, the base product (such as a CD account or a savings account) may act as a security for the associated product (such as a loan or a credit card account). The base product and associated product may also be linked to permit funds to be transferred from one account (such as the base product) to another account (such as the associated product). In addition, the base product and associated product may permit the customer to add or link other financial accounts of the customer that are pre-existing or opened in the future.

Referring to FIG. 3A, the process begins when a customer makes contact with financial institution 170 and requests a financial product (e.g., a “base product”) offered by the financial institution (step 305). In accordance with the exemplary system environment of FIG. 1, this step can be performed by any one of customers 110A-110N communicating with financial institution 170 through communication channel 140. If, for example, a customer contacts the financial institution by telephone, the call may be connected or routed to a customer call center or operator to handle the request from the customer. The customer contact may also be handle by a representative or employee of the financial institution. Additionally, such contact may occur at a store or branch location of the financial institution, or handled electronically through email or a Web site of the financial institution.

After the initial contact is made, the financial institution 170 gathers and analyzes customer information (step 310). Customer information may include basic financial information (e.g., salary, outstanding debt, financial assets, etc.) and demographic information (e.g., age, marital status, address, etc.) of the customer that is needed to initiate and process an application for the base product. The customer information may also include the preferences of the customer regarding the terms or features of the base product. Such customer information may be gathered from public records or sources or may be gathered from a questionnaire or application completed by the customer. Assume, as stated in the previous example, that the customer has contacted the financial institution by telephone. In such as case, a call center operator may initiate a sales conversation and ask the customer a number of questions to gather the necessary customer information.

The gathered customer information is then analyzed by the financial institution (step 310). The financial institution may analyze the customer information to determine the financial status or needs of the customer. For example, the customer information may be analyzed to determine if the customer meets certain criteria for offering another financial product (e.g., an “associated product”). The associated product may be any financial product, such as a credit card account or loan, offered by the financial institution. The product criteria may be predefined and based on the financial status of the customer or the preferences of the customer regarding the terms or features of the base product. Assume, for example, that the base product relates to a CD account. In such a case, the customer's preferences regarding the CD deposit amount, the term of the CD account, etc. can be used to determine if the customer meets predetermined solicitation criteria for the associated product. Alternatively, the criteria may simply require that a certain product is requested by a customer before an associated product is offered. For example, a customer's request for a CD account may automatically trigger an offer for a credit card account or loan.

After analyzing the customer information, a determination is made whether to offer one or more associated product(s) to the customer (step 315). As indicated above, whether to offer an associated product may be determined based on the financial history or needs of the customer. Such a determination may also be performed based on pre-defined solicitation criteria or the customer's preferences concerning the features or terms of the base product. If a determination is made to make the offer (step 315; Yes), then the customer is informed of the offer for the associated product (step 325). If a determination is made not to make the offer (step 315; No), then the customer's application for the base product is processed as normal (step 320). In such a case, the financial institution may determine if the customer qualifies for the base product and, if so, process or set-up a new account for the financial product.

As described above, when a determination is made to make the offer (step 315; Yes), the customer may be informed that he/she may qualify for an offer from the financial institution (step 325). The customer may also be prompted or asked if he/she would like to learn more about the offer. If the customer agrees to learn more about the offer, the financial institution may provide an overview of the financial product and the features and terms of the same. The features and terms of the associated product may be similar to that offered to other customers (i.e., at current market rates) or may provide special features, discounts or advantages when the associated product is requested or opened with a base product. After presenting the offer, the customer may be given the option to decline the offer, or accept the offer and determine if they qualify for the associated product. As indicated above, communication between the financial institution and customer may be performed through any suitable communications channel, such as communication channel 140 of the exemplary system environment of FIG. 1.

If the customer declines the offer (step 330; No), then processing of the customer's application for the base product continues as normal (step 320). Such processing may include determining if the customer qualifies for the base product and, if so, processing or establishing a new account for the financial product. If the customer accepts the offer (step 330; Yes), then processing continues to process the customer's application for the base product and the one or more associated product(s) (step 335). In this case, the financial institution 170 may determine if the customer qualifies for the base product and associated product and, if so, process or establish new accounts for the financial products.

FIG. 3B is an exemplary flowchart of a method for processing a customer's application for a set of combined financial products. The exemplary process of FIG. 3B may be performed as part of step 335 in FIG. 3A. As illustrated in FIG. 3B, the process begins by analyzing information of the customer (step 340). As indicated above, customer information may include credit history information obtained from one or more sources (such as credit bureau 150 in FIG. 1), financial information (e.g., salary, outstanding debt, financial assets, etc.) and demographic information (e.g., age, marital status, address, etc.). Such customer information may be gathered from public records or sources. Alternatively, or in addition to using public sources, customer information may be gathered from a questionnaire or an application completed by the customer prior to or after the contact is made. The customer information may be analyzed by the financial institution to determine if the customer qualifies for the requested financial products. Conventional methods may be utilized to determine if the customer has sufficient credit or funds to qualify for each of the products. If the customer is not approved (step 345; No), then processing terminates with a notification (e.g., written or verbal notification) to the customer that he/she was not approved for the financial products (step 350). If, however, the customer has been approved (step 345; Yes), then processing continues in FIG. 3B to set-up and initiate the financial accounts for the customer.

If, however, the customer has been approved (step 345; Yes), then processing continues in FIG. 3B to set-up and initiate the financial products for the customer. In particular, accounts for the base product and associated product(s) are opened for the customer (step 355). This step may be performed by creating one or more account records in a database (such as database 180 in FIG. 1). Each account record may be associated with a customer and include the customer's name and mailing address. Account records may also include information concerning the terms and features of the account, and information indicating any specific requirements for activating the account (such as the deposit of funds and/or the acknowledgement and signature of an account agreement). In addition, account records may be linked or associated with one another to indicate their relationships or properties. For example, account records may include information indicating whether the account record acts a security for another account or whether funds may be transferred between the account and another account.

If either the base product or the associated product have specific requirements that must be met before they can be activated, then the customer is informed of the requirements (step 360). Assume, for example, that the base product corresponds to a CD account and that the associated product is a credit card account secured by the CD account. In such a case, the customer may be required to provide the full CD deposit amount before the CD account and the credit card account are activated. In addition, the customer may be required to review and sign an agreement that defines the terms and conditions of the CD account, including the security arrangement between the CD and credit card accounts. Such an agreement may be mailed or electronically sent to the customer when providing notification of the requirements for activating the accounts.

After the customer is informed of the requirements (if any) to activate each of the accounts (step 360), the financial institution may monitor and wait until the requirements are satisfied by the customer (step 365). Assume, once again, that the customer is required to deposit funds to activate one or more of the accounts. In such a case, the financial institution would monitor and determine if the appropriate funds were provided by the customer. Funds from a customer may be provided by cash, check or electronically transfer or wire to the financial institution. If the customer is also required to review and return a signed agreement, then the financial institution would also monitor and wait until this requirement was met. If the customer fails to meet the requirements within a certain time period (step 365; No), then financial institution may send a reminder to the customer and/or provide additional time to meet the requirements before closing the accounts. If, however, the customer meets the requirements (step 365; Yes), then the financial institution may activate the accounts (step 370). As part of this step, the financial institution may send notification or a welcoming packet to the customer to provide all relevant information concerning the accounts (such as the account number, balance, contact information, maintenance information, etc.). If an account includes a transaction card (such as a credit or debit card) or other materials (such as software for on-line transactions), then such material may also be sent to the customer. In certain cases (such as a credit card account), the customer may be further required to contact the financial institution to activate the transaction card and establish a password or other security information for the account.

As with the other embodiments disclosed herein, the principles of FIGS. 3A and 3B are not limited to use with a base product and an associated product. Rather, the features of FIGS. 3A and 3B may be adapted to provide any set of financial products to a customer. In addition, various steps in FIGS. 3A and 3B may be modified or changed depending on the set of financial products that are offered to the customer. For example, if there are no requirements for activating a financial account, steps 360 and 365 of FIG. 3B may be skipped for that account.

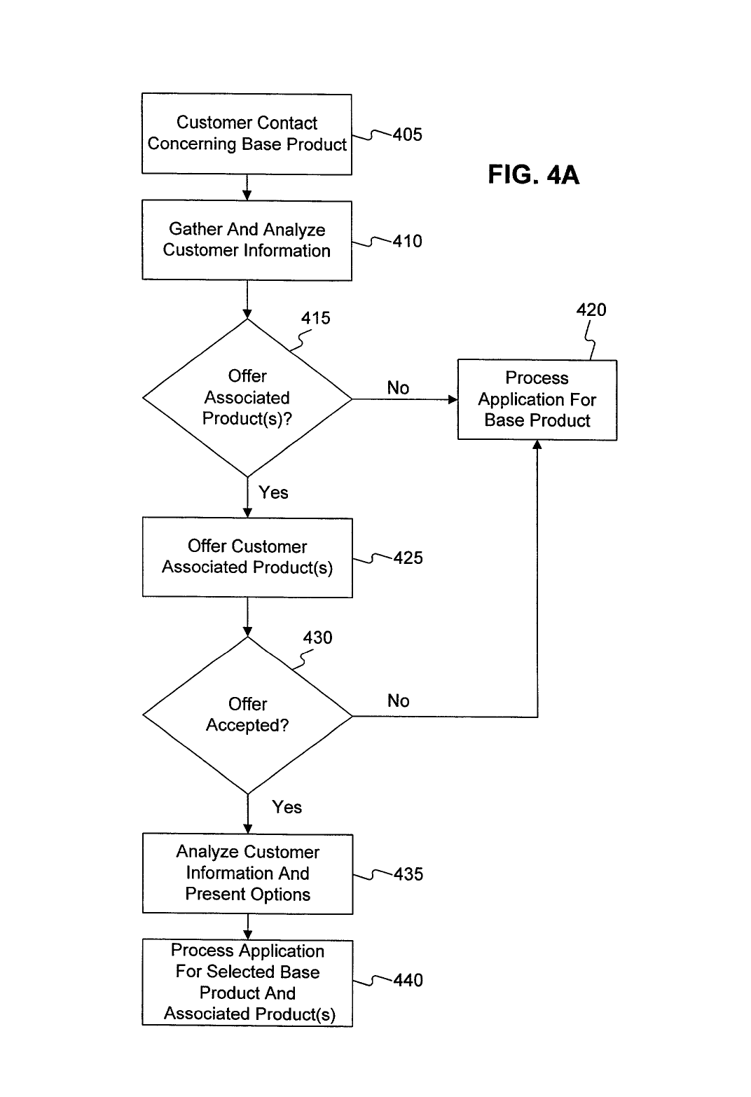

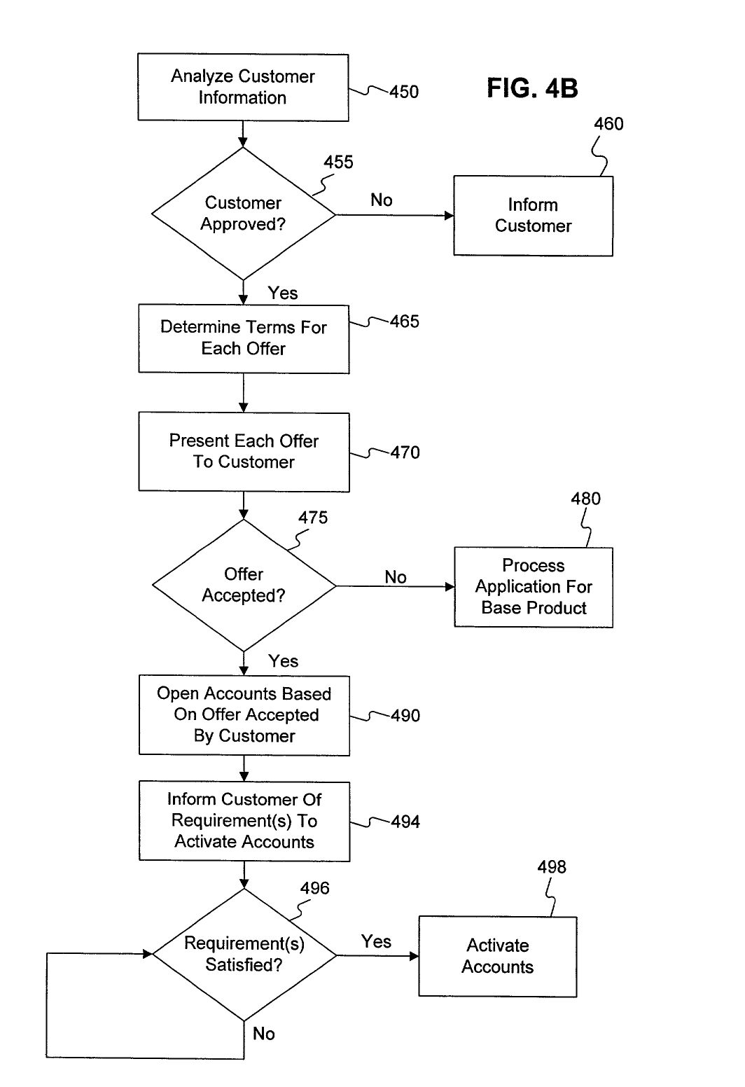

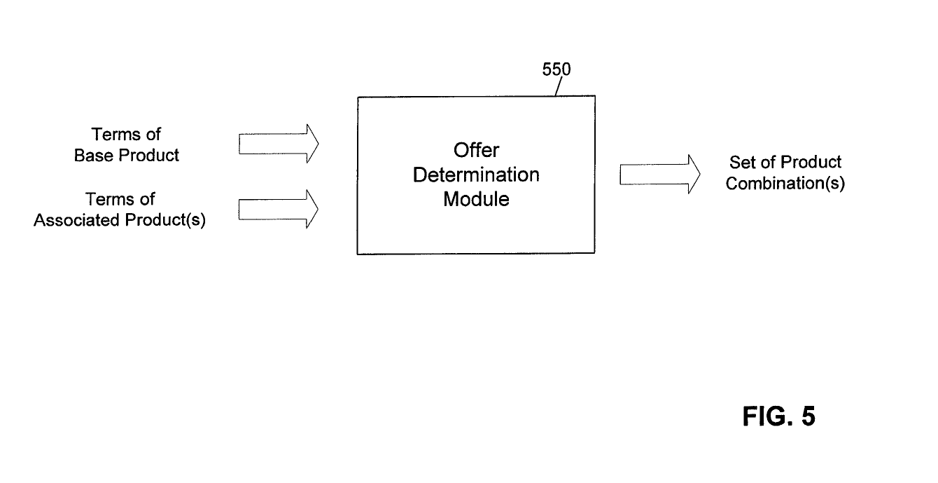

Consistent with the principles of the invention, FIGS. 4A and 4B illustrate additional exemplary embodiments for offering and providing financial products. In the exemplary embodiments of FIGS. 4A and 4B, one or more product combinations are offered to a customer using an offer determination module (further described below with reference to FIG. 5). For purposes of illustration, the embodiments of FIGS. 4A and 4B will be described with reference to a base product corresponding to a CD account and an associated product relating to a credit card account. However, the exemplary embodiments are not limited to such financial products and may be adapted to provide any set of financial products, consistent with the principles of the invention.

Referring to FIG. 4A, the process begins when a customer makes contact with financial institution 170 to request a financial product (e.g., a “base product”) offered by the financial institution (step 405). The base product may correspond, for example, to a CD account advertised or marketed by the financial institution. As illustrated in FIG. 1, customer contact can be performed by any one of customers 110A-110N communicating with financial institution 170 through communication channel 140. If, for example, a customer contacts the financial institution at a store or branch location, the customer may be serviced by a representative or employee of the financial institution. Alternatively, customer contact may be made by telephone or through a Web site of the financial institution. In the former case, the customer may be routed (using, for example, a voice response unit (VRU)) to a customer call center or operator. In the later case, communication with the customer may be handled through interactive Web pages or using email.

After the initial contact is made, the financial institution gathers and analyzes customer information (step 410). Customer information may include basic financial information (e.g., salary, outstanding debt, financial assets, etc.) and demographic information (e.g., age, marital status, address, etc.) of the customer. The customer information may also include the preferences of the customer regarding the terms or features of the base product. Such customer information may be gathered from public sources and/or collected from a questionnaire or application completed by the customer. Assume, for example, that the customer has contacted the financial institution through a Web site. In such as case, interactive Web pages may be used to prompt the customer and gather the necessary information. If customer contact is made by phone, then a sales conversation may be initiated with the customer being asked a series of questions to gather the necessary information.

The gathered customer information is then analyzed by the financial institution (step 410). The financial institution may analyze the customer information to determine the financial status or needs of the customer. For example, the customer information may be analyzed to determine if the customer meets certain criteria for another financial product (e.g., an “associated product”) offered by the financial institution. The associated product may be any financial product, such as a credit card account. The product criteria may be predefined and based on the financial status of the customer or the preferences of the customer regarding the terms or features of the base product. Assume, once again, that the base product relates to a CD account. In such a case, the customer's preferences regarding the CD deposit amount, the term of the CD account, etc. can be used to determine if the customer meets predetermined solicitation criteria for one or more associated products.

After analyzing the customer information, a determination is made whether to offer one or more associated product(s) to the customer (step 415). For example, as stated above, predetermined solicitation criteria may be used to determine if the customer's preferences match a customer profile for the associated product. Thus, if the base product corresponds to a CD account and the associated product is a credit card account, the customer's preferences regarding the CD deposit amount and term of the CD deposit may be analyzed to determine if the customer's preferences match a profile for offering a credit card account or another financial product. Alternatively, associated product(s) may be automatically offered whenever a specific base product is requested by a customer. Thus, if a customer contacts the financial institution regarding a CD account, the customer may automatically be offered an associated product, such as a credit card account.

If a determination is made to make the offer (step 415; Yes), then customer is informed of the offer for the associated product(s) (step 425). If a determination is made not to make the offer (step 415; No), then the customer's application for the base product is processed as normal (step 420). In such a case, the financial institution may determine if the customer qualifies for the base product and, if so, proceed to set-up a new account for the financial product. The customer's qualification for the base product may be determined based on the customer's financial and/or credit history.

When a determination is made to make an offer (step 415; Yes), the customer may be informed that he/she may qualify for the offer from the financial institution (step 425). As indicated above, communication between the financial institution and customer may be performed through any suitable communications channel, such as communication channel 140 of the exemplary system environment of FIG. 1. When the offer is presented (either verbally, electronically or by written communication), the customer may be prompted or asked if he/she would like to learn more about the offer. If the customer agrees to learn more about the offer, the financial institution may provide an overview of the financial product(s) and the features and terms of the same. The features and terms of the associated product may be similar to that offered to other customers (i.e., products offered at current market rates) or may provide special features, discounts or advantages when the associated product is opened or activated with the base product.

After presenting the offer, the customer may be given the option to decline the offer, or accept the offer and determine if they qualify for the associated product(s). If the customer declines the offer (step 430; No), then processing of the customer's application for the base product continues as normal (step 420). Such processing may include determining if the customer qualifies for the base product and, if so, processing or establishing a new account for the financial product. Once again, the customer's qualification for the base product may be determined based on the customer's financial and/or credit history.

If the customer accepts the offer (step 430; Yes), then processing continues to analyze the customer information to provide different options for the customer (step 435) and process the customer's application for the selected base product and associated product(s) (step 440). As further described below, a customer may be given the option to select from one or more different product combinations, where each combination includes different set of rates or terms for the base product and associated product. For example, a customer may be given the option to select the base product and associated product at current market rates. The customer could also be given the option to select a product combination in which the base product and/or the associated product has optimized rates or terms.

FIG. 4B is an exemplary flowchart of a process may be performed as part of steps 435 and 440 in FIG. 4A. As illustrated in FIG. 4B, the process begins by analyzing the customer information (step 450). As indicated above, customer information may include the customer's financial information (e.g., salary, outstanding debt, financial assets, etc.) and demographic information (e.g., age, marital status, address, etc.). Customer information may also include a customer's credit history or rating. If, for example, a customer's credit history or rating was not previously gathered (e.g., at step 410 in FIG. 4A), then such information may be additionally gathered at step 450 from one or more public sources (such as credit bureau 150 in FIG. 1).

The customer information, including a customer's credit rating (such as a FICO score or rating) and other financial information, may be used by the financial institution to determine if the customer qualifies for the offered financial product(s) (step 455). Consistent with the principles of the invention, conventional methods may be utilized to determine if the customer has sufficient credit or funds to qualify for each of the offered financial products. In addition, real-time decisioning tools may be used to provide a quicker response to the customer. Such tools are useful for on-line or telephone-based communications with the customer, where a quicker response rate is anticipated by a customer as compared with an application process handled through written communication.

In some cases, the approval requirements for a financial product may be set very low. For example, a CD account, savings account or debit card may have very minimum financial or credit requirements. In contrast, other financial products may have relatively strict approval requirements. For example, a loan or credit card account may require that the customer have a good credit history or rating, as well as proof of employment or adequate sources of income. If a customer has a poor credit rating, then the customer may be required to provide some form of security for the financial product (such as for a secured credit card account).

Systems and methods consistent with the principles of the invention also provide associated financial products where the terms (i.e., market interest rate, fees, etc.) of each financial product are set to provide maximum utility and benefit to the customer, while also providing acceptable rates of return and/or benefit to the financial institution. The terms that are offered to the customer may be set more competitive than current market terms due to the manner in which the financial products are associated with one another. For example, one of the financial products may act as a security for the other financial product. By providing this security aspect, the risk premium related to the secured financial product is lowered and, therefore, more competitive terms can be offered to the customer. Thus, it is possible that a customer with a good credit rating may be given the option to provide some form of security for a financial product to get preferential or improved terms on the financial product or an associated financial product.

Referring again to FIG. 4B, if it is determined that the customer does not qualify for one or more of the financial products (step 455; No), then processing terminates with notification to the customer (step 460). As indicated above, the notification may be written or verbal and indicate to the customer that they were not approved for the financial products. The reasons for denying approval may also be included in the notification. If, however, the customer has been approved (step 455; Yes), then processing continues to step 465 in FIG. 4B.

At step 465, the financial institution determines the rates and terms of each offer to present to the customer (step 465). As indicated above, one or more different product combinations may be offered to the customer, where each product combination includes different sets of rates and terms for the base product and the associated product(s). This permits the customer to have more freedom to select a product combination that best fits their financial needs or requirements. The financial institution may analyze the customer information, including financial and credit information and the customer's indicated preferences, to determine the set of offers to present to the customer.

Consistent with the principles of the invention, an offer determination module may be utilized by the financial institution to determine the set of offers for each customer. The offer determination module, such as module 550 illustrated in FIG. 5, may be implemented through any suitable combination of hardware, software and/or firmware. For example, offer determination module 550 may be a software-based application that is executed by a computer or server of the financial institution. Generally, offer determination module 550 analyzes the terms of the base product requested or available to the customer, and analyzes the terms of each associated product offered or available to the customer. With this information offer determination module 550 generates one or more product combinations, in which each combination has a unique set of rates or terms for the base product and associated product(s).

For purposes of illustration, assume that the base product is a CD account and that the associated product is a credit card account. In such a case, offer determination module 550 may receive, as input, the deposit amount and duration (i.e., time to maturity) of the CD account requested by the customer. Offer determination module 550 may also receive, as input, information indicating the type of associate product(s) that were approved for the customer. If the associated product is a credit card account, then this information may include the available market interest rate and security requirements (if any) for the credit card account. Offer determination module 550 may generate one or more product combinations (such as a CD and a credit card account) for the customer based on information concerning the terms of the base product and associated product. The terms of the products themselves may be set according to the financial institution's internal cost of funds, the risk profile of the customer, and the expected usage of the credit product.

To generate the different product combinations, source tables may be utilized. Consistent with the principles of the invention, source tables may be stored by a financial institution 170 (using, for example, database 180) to provide different sets of rates or terms for each financial product. For example, based on the terms of the base product requested or available to the customer, a source table for the base product may be consulted to determine a set of different rates for the product (e.g., a market rate, a ceiling rate and a floor rate). These rates may be paired with a set of rates for the associated product using a separate source table for the associated products. Alternatively, source tables may be provided for predetermined product combinations or a master source table may be provided for determining the rates for all possible product combinations offered by the financial institution.

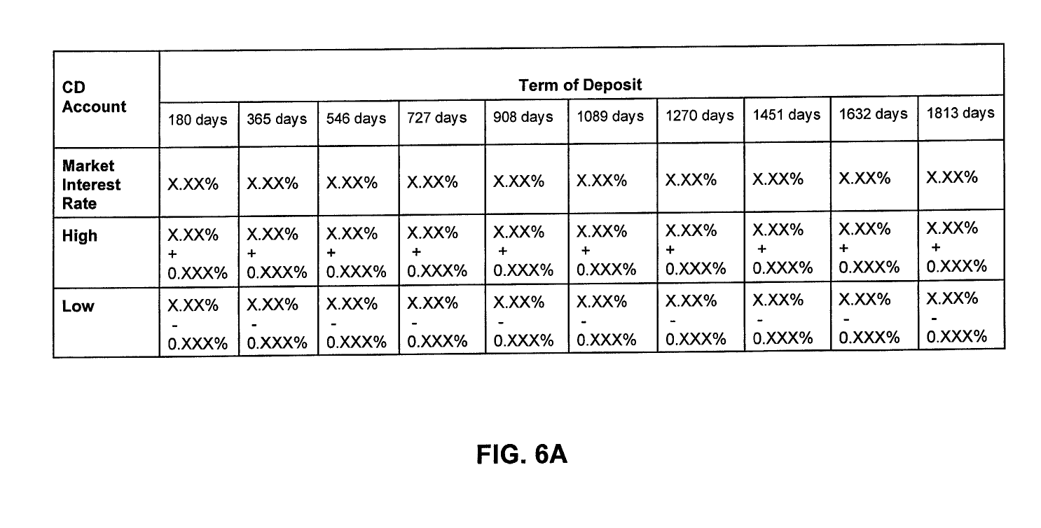

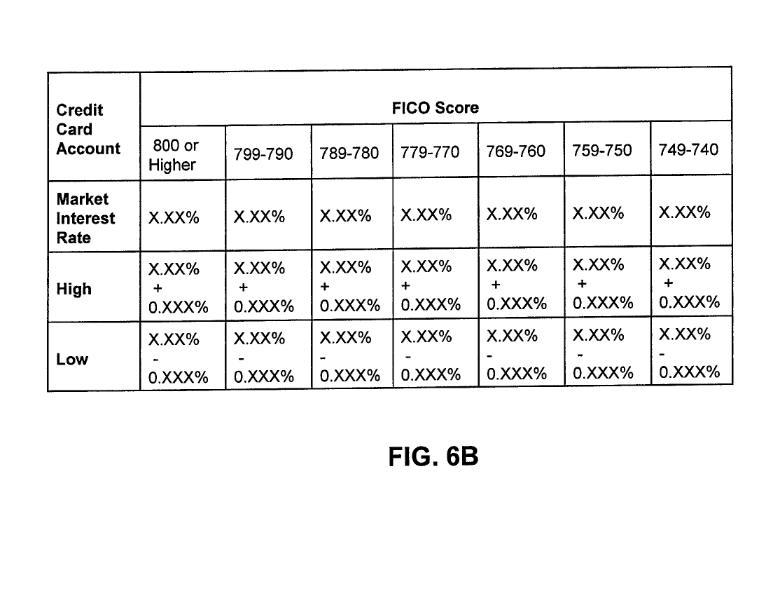

FIGS. 6A and 6B illustrate exemplary source tables that may be utilized by, for example, offer determination module 550. Assume, for example, that the base product is a CD account and that the associated product is a credit card account. A source table for the CD account (such as FIG. 6A) and a source table for the credit card account (such as FIG. 6B) may be utilized by offer determination module 550 to generate a set of product combinations. With the input provided to the offer determination module, the source tables may be consulted to generate a set of product combinations to offer to the customer.

As illustrated in FIG. 6A, the source table for a CD account may be structured into segments according to term ranges that correspond to the different CD terms offered by the financial institution. For example, the term ranges may be divided in days or months to represent the time to maturity (e.g., 6 months, 1 year, etc.). Each segment may be linked to a current market interest rate for CD accounts with a similar term to maturity. High and low interest rates may also be provided for each segment, which may represent the ceiling and floor rates or any incremental rates in between. Other terms related to the CD account (such as withdrawal restrictions, penalties for early withdrawal, etc.) may also be provided for each segment to vary other terms in each offer.

The source table for a credit card account may also be segmented. As illustrated in FIG. 6B, the source table may be structured into segments representing different credit score ranges (such as FICO score ranges). In addition, each segment may be linked to a current market interest rate for similar credit card accounts. High and low interest rates may also be provided for each segment, which may represent the ceiling and floor rates or any incremental rates in between. As with the source table for the CD account, other terms related to the credit card account (such as annual fees, usage requirements, etc.) may also be provided for each segment in the table to vary other terms in each offer.

Source tables, such as the examples of FIGS. 6A and 6B, may be updated periodically based on the financial products offered by the financial institution and a number of other factors (such as prevailing market rates, internal costs for offering or providing a financial product, the required profit margin for a financial product, etc.). Such updates may be entered manually (e.g., by an employee of the financial institution using a computer or workstation) so that the rates and other terms for each segment are current for each financial product. Updates to a source table can also be performed automatically using a computer or software-controlled process. In such a case, the necessary data (such as market rates, internal costs, required profit margins, etc.) may be collected from resources within the financial institution to determine and adjust the rates and/or other terms for each segment in a source table.

The market rates for a financial product may be set through consideration of the company's internal cost of funds (such as a Funds Transfer Price (FTP)), the costs of servicing and maintaining the account, and rates offered by similar financial service providers. A company's internal cost of funds is derived by a weighed average of the different funding vehicles the company uses to finance transactions.

Based on the CD deposit amount requested by the customer, offer determination module 550 may locate the appropriate source table (such as FIG. 6A) for a CD account of a similar type (i.e., a CD account having the same or similar deposit requirements). The offer determination module then uses the term of deposit requested by the customer to locate a matching segment in the source table. Once a matching segment is located, the linked market interest rate and other rates (e.g., high and low interest rates) are located from the source table.

A similar process is performed using a source table for the associated product (i.e., a credit card account). For example, based on the type of credit card account for which the customer is approved, offer determination module 550 locates the appropriate source table (such as FIG. 6B) for a credit card account of a similar type (i.e., a credit card account with the same or similar terms or requirements). The offer determination module then uses the credit rating or score (such as a FICO score) to locate a matching segment in the source table and linked rates. If the credit card account requires a security, the offer determination module may adjust the FICO score of the customer to locate a matching segment. For example, in order adjust for the security deposit, the customer's FICO score may be increased by a predetermined value (such as 10) to provide for an adjusted FICO score. The adjusted score may then be used to locate a matching segment in the source table. Once a matching segment is located, the linked market interest rate and other rates (e.g., high and low interest rates) are determined from the source table.

The rates offered for a given credit product are set by a combination of the company's internal costs of funds and a profitability premium, which accounts for average customer default and a fair rate of return for the company. Once a market interest rate is established for the credit product, the combined profitability of the deposit and credit products, determined by interest rates charged/yielded and expected usage patterns on the credit product, establishes a baseline of return (i.e., expected net present value (NPV)) for the “packages” of rates. This value is populated into the source table and serves as the basis of offer for a customer that requests a given term of deposit and has a FICO score corresponding to a given credit product when referenced by offer determination module 550. The HIGH/HIGH and LOW/LOW packages offer rates are calculated by a similar NPV calculations, as determined by expected credit usage patterns and revenue/costs of the credit product, as well as the effect of paying higher or lower interest on the deposit. These values are similarly populated into the source table and serve as the basis of offer for a customer that requests a given term of deposit and has a FICO score corresponding to a given credit product when referenced by the offer determination module 550.

After determining the different rates for the base product (the CD account) and the associated product (the credit card account), offer determination module 550 generates a set of product combinations with different paired rates (e.g., MARKET/MARKET, HIGH/HIGH and LOW/LOW). Thus, one product combination may offer the CD and credit card accounts at market rates (market/market). Another product combination may offer the CD and credit card accounts at increased rates (HIGH/HIGH). Still another product combination may offer the CD and credit card accounts and decreased rates (LOW/LOW). Other terms and conditions of the accounts (such as annual fees, money transfer restrictions, payment cycle definitions, usage requirements, etc.) may also be adjusted to provide different product combinations. Further, different structured rates may also be offered for the base product and associated product (MARKET/HIGH, HIGH/MARKET, MARKET/LOW, LOW/MARKET, HIGH/LOW, LOW/HIGH, etc.).

Referring again to FIG. 4B, after the rates and terms of each offer are determined, the offers are presented to the customer (step 470). In order to permit the customer to make an informed decision, each of the offers may be explained in detail to the customer either verbally, by written communication, or by email or content presented through Web pages. The cost savings and overall benefits of each option may also presented to the customer, so that the customer can intelligently distinguish between each of the offers and determine the option that best fits their financial needs or requirements.

After the offers are presented to the customer (step 470), a determination is made whether the customer has accepted or selected any of the offers (step 475). If the customer decides not to select any of the offers (step 475; No), then application processing for the base product may continue as normal. Alternatively, the customer may be given the option to have additional time to make a selection (such as one ore more days) or the option to cancel the entire process. If, however, the customer selects one of the offers (step 475; Yes), then accounts for the selected base product and associated product(s) are opened for the customer (step 490). This step may be performed by the financial institution by creating one or more account records in a database (such as database 180 in FIG. 1). Each account record may be associated with a customer and include the customer's name and mailing address. Account records may also include information concerning the particular terms and features of the selected account, and information indicating any specific requirements (such as the deposit of funds or the acknowledgement and signature of an agreement) for activating the account. Accounts requiring specific requirements before activation may be placed on hold or made inactive pending satisfaction of the requirements. If an account does not have any specific requirements for activation, then the account may be immediately activated and made available to the customer.

If either the selected base product or associated product have specific requirements that must be met before they can be activated, then the customer is informed of the requirements (step 494). Assume, once again, that the base product corresponds to a CD account and that the associated product is a credit card account. Also assume that the credit card account will be secured by the CD account. In such a case, the customer may be required to provide the full CD deposit amount before the CD account and the credit card account are activated. In addition, the customer may be required to review and sign an agreement that acknowledges the terms and conditions of the accounts. Such an agreement may be mailed or electronically sent to the customer when providing notification of the requirements for activating the accounts.

After the customer is informed of the requirements (if any) to activate each of the selected accounts (step 494), the financial institution may monitor and wait until the requirements are satisfied by the customer (step 496). Assume, once again, that the customer is required to deposit funds to activate one or more of the accounts. In such a case, the financial institution would monitor and determine if the appropriate funds were provided by the customer. Funds from a customer may be provided by cash, check or electronically transfer or wire to the financial institution. If the customer is also required to review and return a signed agreement, then the financial institution would also monitor and wait until this requirement was met. If the customer fails to meet the requirements within a certain time period (step 496; No), then financial institution may send a reminder to the customer and/or provide additional time to meet the requirements before closing the selected accounts. If, however, the customer meets the requirements (step 496; Yes), then the financial institution may activate the accounts (step 498). As part of this step, the financial institution may send notification or a welcoming packet to the customer to provide all relevant information concerning the selected accounts (such as the account number, balance, contact information, maintenance information, etc.). If an account includes a transaction card (such as a credit or debit card) or other materials (such as software for on-line transactions), then such material may also be sent to the customer.

Each of the offers presented to the customer may include usage requirements to maintain the special interest rates. For example, a product combination offering the CD account with a high interest rate may include predetermined usage requirements for the associated product (such as 4 credit card transactions per month). If the usage requirements are not satisfied, the customer may be penalized or the rates for the products may be revert back to the current market rates until the requirements are again satisfied by the customer.

Other embodiments of the invention will be apparent to those skilled in the art from consideration of the specification and practice of the invention disclosed herein. For example, while several of the embodiments disclosed herein have been described with reference to a CD account and a credit card account, it will be appreciated that these embodiments are exemplary and that the principles of the invention may be implemented with any combination of financial products. For instance, any financial product for investing (such as a savings account, a money market account, a CD account, or a bond) may be combined with another product for investing and/or a financial product for conducting transactions (such as a checking account, a debit card account, a credit card account, a loan or a mortgage). In addition, in accordance with the principles of the invention, the base product could be a financial product for conducting transactions and the associated product could be a financial product for investing. For instance, the embodiment of FIGS. 4A and 4B could be modified such that the base product is a credit card account requested by the customer and the associated product is a CD account offered by the financial institution.

In addition, the invention is not limited to the particulars of the embodiments disclosed herein. For example, the individual features of each of the disclosed embodiments may be combined or added to the features of other embodiments. In addition, the steps of the disclosed methods herein may be combined or modified without departing from the spirit of the invention claimed herein. For example, steps 455 and 465 of FIG. 4B may be reordered (to determine if the customer is approved before determining the terms of the offers) or combined (to occur substantially simultaneously), consistent with the principles of the invention.

Accordingly, it is intended that the specification and examples be considered as exemplary only, with a true scope and spirit of the invention being indicated by the following claims.

What is claimed is:

1. A method for providing financial products, the financial products including a base product and at least one associated product, the method comprising:
receiving a request from a customer concerning the base product;
gathering customer information in response to the request from the customer, the customer information including a customer's preferences regarding the base product;
determining, based on the customer information, whether predetermined solicitation criteria is satisfied for offering at least one associated product;
presenting, if the predetermined solicitation criteria is satisfied, an offer to the customer for the associated product; and
processing, if the offer is accepted by the customer, an application for the base product and the associated product.

2. The method of claim 1 wherein gathering includes presenting a set of questions to the customer to gather the customer information.

3. The method of claim 1 wherein the customer information further includes credit information of the customer, and wherein gathering includes accessing a credit bureau to locate the credit information of the customer.

4. The method of claim 1 wherein presenting includes presenting an offer for the base product and the associated product at current market rates.

5. The method of claim 1 wherein presenting includes presenting an offer for the base product and the associated product at increased interest rates.

6. The method of claim 1 wherein presenting includes presenting an offer for the base product and the associated product at decreased interest rates.

7. The method of claim 1 further comprising:
linking the base product and the associated product such that the base product acts as a security for the associated product.

8. The method of claim 7 wherein the base product is a CD account and the associated product is a secure credit card account.

9. The method of claim 1 wherein presenting includes presenting a set of offers for the base product and the associated product to the customer, wherein each offer includes a unique combination of rates for the base product and the associated product.

10. The method of claim 9 further comprising:
processing an application for the base product if the customer rejects the offers for both the base product and the associated product.

11. The method of claim 9 further comprising
processing, if one of the offers is selected by the customer, an application for the base product and the associated product corresponding to the selected offer.

12. The method of claim 9 further comprising
generating the set of offers for the base product and the associated product based on the customer's preferences concerning the base product.

13. The method of claim 12 wherein the base product is a CD account and the associated account is a credit card account, and further wherein the customer's preferences include a CD deposit amount and a term of deposit.

14. The method of claim 1 further comprising
processing an application for the base product if the customer rejects the offer for the associated product.

15. The method of claim 9 further comprising
processing, if one of the offers is selected by the customer, an application for the base product and the associated product in accordance with the offer presented to the customer.

16. The method of claim 1 wherein the base product is a CD account and the associated account is a credit card account, and further wherein the customer's preferences include a CD deposit amount and a term of deposit.

17. A system for providing financial products, the financial products including a CD account and a credit card account, the system comprising:
means for receiving a request from a customer concerning the CD account;
means for gathering customer information;
means for generating, in response to the request from the customer, at least one offer for the CD account and the credit card account, the offer including interest rates for the CD account and the credit card account that are adjusted based on the customer information;
means for presenting, to the customer, the offer for the CD account and the credit card account; and
means for processing an application for the CD account and the credit card account if the offer is accepted by the customer.

18. The system of claim 17 wherein the gathering means includes means for presenting a set of questions to the customer to gather the customer information.

19. The system of claim 17 wherein the customer information includes credit information for the customer, and wherein the gathering means includes means for accessing a credit bureau to locate the credit information for the customer.

20. The system of claim 17 further comprising
means for linking the CD account and the credit card account such that the credit card account acts as a security for the CD product.

21. The system of claim 17 wherein the presenting means includes means for presenting a set of offers for the CD account and the credit card account to the customer, wherein each offer includes a unique combination of rates for the CD account and the credit card account.

22. The system of claim 21 further comprising
means for processing an application for the CD account if the customer rejects the offers for the CD account and the credit card account.

23. The system of claim 21 further comprising
means for processing, if one of the offers is selected by the customer, an application for the CD account and the credit card account in accordance with the offer selected by the customer.

24. The system of claim 17 wherein the customer information includes a customer's preferences regarding the CD account, and wherein the generating means comprises
means for generating the set of offers for the CD account and the credit card account based on the customer's preferences concerning the CD account.

25. The system of claim 24 wherein the customer's preferences include a CD deposit amount and a term of deposit.

26. A method for providing financial products, the financial products including a CD account and a credit card account, the method comprising:
receiving a request from a customer concerning the CD account;
determining, in response to the request from the customer, a customer's preferences regarding the CD account;
generating, based on the customer's preferences regarding the CD account, a set of offers for the CD account and the credit card account, each offer including a unique combination of terms for the CD account and the credit card account;
presenting the set of offers to the customer; and
processing an application for the CD account and the credit card account in accordance with the offer selected by the customer.

27. The method of claim 26 wherein the terms include interest rates applicable to the CD account and the credit card account, and wherein presenting includes presenting an offer for the CD account and the credit card account at current market rates.

28. The method of claim 26 wherein the terms include interest rates applicable to the CD account and the credit card account, and wherein presenting includes presenting an offer for the CD account and the credit card account at interest rates increased from current market rates.

29. The method of claim 26 wherein the terms include interest rates applicable to the CD account and the credit card account, and wherein presenting includes presenting an offer for the CD account and the credit card account at interest rates decreased from current market rates.

30. The method of claim 26 further comprising
linking the CD account and the credit card account such that the CD account acts as a security for the credit card account.

31. The method of claim 26 wherein generating includes
consulting a source table for the CD account and the credit card account to determine the terms for the CD account and the credit card account of each offer.

32. The method of claim 26 further comprising
processing an application for the CD account if the customer rejects the offers for both the CD account and the credit card account.

33. The method of claim 26 wherein the customer's preferences include a CD deposit amount and a term of deposit.

34. A system for providing financial accounts, the financial products including a base product and at least one associated product, the system comprising:
means for receiving a request from a customer concerning the base product;
means for gathering customer information, the customer information including credit information for a customer and a customer's preferences concerning the base product; and
an offer determination module that generates, in response to the request from the customer, at least one offer for the base product and an associated product, the offer including rates for the base product and the associated product that are determined based on the gathered customer information.

35. The system of claim 34 further comprising
means for presenting, to the customer, the at least one offer for the base product and the associated product; and
means for processing an application for the base product and the associated product if the offer is accepted by the customer.

36. The system of claim 34 further comprising
a source table for the ba se product, the source table for the base product being segmented into different term ranges, each term range segment of the source table corresponding to a set of different rates for the base product.

37. The system of claim 34 further comprising
a source table for the associated product, the source table for the associated product being segmented into different credit score ranges, each credit score segment of the source table corresponding to a set of different rates for the associated product.

38. The system of claim 34 wherein the offer determination module includes
means for consulting a source table to determine the rates for the base product and associated product based on the customer information.

39. The system of claim 34 wherein the gathering means includes means for presenting a set of questions to the customer to gather the customer information.

40. The system of claim 34 wherein the gathering means includes means for accessing a credit bureau to locate the credit information for the customer.

41. The system of claim 34 further comprising
means for linking the base product and the associated product such that the associated product acts as a security for the base product.

42. The system of claim 34 further comprising
means for linking the base product and the associated product such that the funds can be transferred between the base product and the associated product.

43. The system of claim 34 wherein the base product is a CD account and the associated product is a credit card account, and further wherein the offer determination module generates a set of offers for the CD account and the credit card account, wherein each offer includes a unique combination of rates for the CD account and the credit card account.

44. The system of claim 43 further comprising
means for presenting, to the customer, the set of offers for the CD account and the credit card account.

45. The system of claim 44 further comprising
means for processing an application for the CD account if the customer rejects the offers for the CD account and the credit card account.

46. The system of claim 44 further comprising
means for processing, if one of the offers is selected by the customer, an application for the CD account and the credit card account in accordance with the offer selected by the customer.

47. The system of claim 43 wherein the customer's preferences include a CD deposit amount and a term of deposit.

48. A method for providing financial accounts, the financial products including a CD account and a credit card account, the method including:
gathering information related to a customer, the customer information including credit information for a customer and a customer's preferences concerning the CD account;
generating, using an offer determination module, at least one offer for the CD account and credit card account, each offer including rates for the CD account and the credit card account that are determined based on the gathered customer information;
presenting each offer to the customer for selection; and
processing, if the offer is selected by the customer, an application for the CD account and the credit card account corresponding to the selected offer.

49. The method of claim 48 further comprising
providing a source table for the CD account, the source table being segmented into different term ranges, each segment of the source table being linked to a set of different rates for the CD account.

50. The method of claim 48 further comprising
providing a source table for the credit card account, the source table being segmented into different credit score ranges, each segment of the source table being linked to a set of different rates for the credit card account.

51. The method of claim 48 wherein generating includes
consulting a source table to determine, for each offer, a set of rates for the CD account and the credit card account based on the customer information.

52. The method of claim 48 wherein gathering includes presenting a set of questions to the customer to gather the customer information.

53. The method of claim 48 wherein gathering includes accessing a credit bureau to locate the credit information for the customer.

54. The method of claim 48 further comprising
linking the CD account and the credit card account such that the CD account acts as a security for the credit card account.

55. The method of claim 48 further comprising
linking the CD account and the credit card account such that funds can be transferred between the CD account and the credit card account.

56. The method of claim 48 wherein generating includes
generating, using the offer determination module, a set of offers for the CD account and the credit card account, wherein each offer includes a unique combination of rates for the CD account and the credit card account.

57. The method of claim 56 further comprising
presenting, to the customer, the set of offers for the CD account and the credit card account.

58. The method of claim 57 further comprising
processing an application for the CD account only if the customer rejects the offers for both the CD account and the credit card account.

59. The method of claim 57 further comprising
processing, if one of the offers is selected by the customer, an application for the CD account and the credit card account in accordance with the offer selected by the customer.

60. The method of claim 48 wherein the customer's preferences include a CD deposit amount and a term of deposit.

61. A method for providing financial accounts, the financial products including a first financial account and a second financial account, the method including:
gathering information related to a customer, the customer information including credit information for a customer and a customer's preferences concerning the first financial account;
generating at least one offer for the first financial account combined with the second financial account, each offer including terms for the first financial account and the second financial account that are determined based on the gathered customer information;
presenting each offer to the customer for selection; and
processing, if the offer is selected by the customer, an application for the first financial account and the second financial account corresponding to the selected offer.

62. The method of claim 61 wherein the first financial account is a financial account for investing.

63. The method of claim 62 wherein the first financial account is a savings account, a money market account, a CD account, or a bond.

64. The method of claim 62 wherein the second financial account is a financial account for conducting transactions.

65. The method of claim 64 wherein the second financial account is a checking account, a debit card account, a credit card account, a mortgage or a loan.

66. The method of claim 61 wherein the first financial account is a financial account for conducting transactions.

67. The method of claim 66 wherein the first financial account is a checking account, a debit card account, a credit card account, a mortgage or a loan.

68. The method of claim 66 wherein the second financial account is a financial account for investing.

69. The method of claim 68 wherein the second financial account is a savings account, a money market account, a CD account, or a bond.

70. The method of claim 61 further comprising linking the financial accounts such that the first financial account as a security for the second financial account.
